(19) United States
(12) Patent Application Publication
(10) Pub. No.: US 2025/0378527 A1
(43) Pub. Date: Dec. 11, 2025

(54) SYSTEM AND METHOD FOR PROCESSING MEDIA DATA IN A VIRTUAL REALITY ENVIRONMENT

(71) Applicant: SAMSUNG ELECTRONICS CO., LTD., Suwon-si (KR)

(72) Inventors: Vipul GUPTA, Noida (IN); Vaibhav NEGI, Noida (IN)

(73) Assignee: SAMSUNG ELECTRONICS CO., LTD., Suwon-si (KR)

(21) Appl. No.: 19/076,462

(22) Filed: Mar. 11, 2025

Related U.S. Application Data
(63) Continuation of application No. PCT/KR2025/001869, filed on Feb. 7, 2025.

(30) Foreign Application Priority Data
Jun. 7, 2024 (IN) 202411044361

(51) Int. Cl. G06T 3/40; G06T 7/70; G06T 15/00

(52) U.S. Cl. CPC G06T 3/40; G06T 7/70; G06T 15/00; G06T 2200/04

(57) ABSTRACT

A method for processing media data in a virtual reality (VR) environment, includes receiving the media data associated with the VR environment; obtaining low-resolution media data of the VR environment from the media data based on network bandwidth capabilities associated with a user device of a user; identifying at least one region within the low-resolution media data based on contextual information associated with the user in the VR environment; and obtaining high-resolution media data corresponding to the low-resolution media data, the high-resolution media data being associated with the at least one region.

### CROSS-REFERENCE TO RELATED APPLICATIONS

This application is a continuation of International Application No. PCT/KR2025/001869 designating the United States, filed on Feb. 7, 2025, in the Korean Intellectual Property Receiving Office and claiming priority to Indian Patent Application number 202411044361, filed on Jun. 7, 2024, in the Intellectual Property India, the disclosures of each of which are incorporated by reference herein in their entireties.

### BACKGROUND

### Field

The present disclosure relates to virtual reality environments, and more particularly, relates to a system and method for processing media data in a virtual reality (VR) environment.

### Description of Related Art

A virtual reality (VR) environment is a simulated digital space in which users can immerse themselves using, e.g., a head-mounted display and motion-tracking technology, creating a sense of presence in a virtual world. A metaverse takes this concept further by connecting multiple VR environments into a cohesive and interconnected virtual universe, where users can seamlessly move between different experiences, interact with others in real time, and engage in various activities such as gaming, socializing, shopping, and more. Generally, the metaverse may be referred to as an aggregate virtual shared space where users can connect for various purposes. An increasing usage of the metaverse is evident in industries like gaming, education, and virtual meetings, to enhance an immersive experience and interactions among users. Usually, to depict a detailed virtual environment within the metaverse, a large amount of data is downloaded over the internet, which includes 3D avatars, an ambience, and other interactive elements. Therefore, there is great dependency on internet bandwidth because large amounts of data need to be downloaded.

To address internet and bandwidth related issues, related dynamic content loading solutions are mostly cloud-based. Dynamic content loading may reduce bandwidth load by limiting downloads based on the field of view of a user in the metaverse. As related dynamic content solutions are mainly based on bandwidth requirements without consideration of other essential aspects of content delivery, such solutions may lead to inefficient content delivery and poor user experience.

Therefore, in view of the above-mentioned problems, it is advantageous to provide an improved system and method that can overcome the above-mentioned problems and limitations associated with processing and rendering of data in a metaverse over limited bandwidth.

### SUMMARY

This summary is provided to introduce a selection of concepts that are further described in the detailed description of the disclosure. This summary is neither intended to identify key or essential inventive concepts of the disclosure nor is it intended for determining the scope of the disclosure.

According to an embodiment of the present disclosure, disclosed herein is a method for processing media data in a virtual reality (VR) environment. The method includes receiving the media data associated with the VR environment; obtaining low-resolution media data of the VR environment from the media data based on network bandwidth capabilities associated with a user device of a user; identifying at least one region within the low-resolution media data based on contextual information associated with the user in the VR environment; and obtaining high-resolution media data corresponding to the low-resolution media data, the high-resolution media data being associated with the at least one region.

According to another embodiment of the present disclosure, also disclosed herein is a system for processing media data in a virtual reality (VR) environment. The system includes memory storing instructions; and at least one processor operatively connected to the memory, and configured to execute the instructions. The instructions, when executed by the at least one processor, cause the system to receive the media data corresponding to the VR environment; obtain low-resolution media data of the VR environment from the media data based on network bandwidth capabilities associated with a user device of a user; identify at least one region within the low-resolution media data based on contextual information associated with the user in the VR environment; and obtain high-resolution media data corresponding to the low-resolution media data, the high-resolution media data being associated with the at least one region.

According to another embodiment of the present disclosure, also disclosed herein is a non-transitory computer-readable medium storing instructions. The non-transitory computer-readable medium storing instructions includes one or more instructions, the instructions when executed by one or more processors, causes the one or more processors to: receive media data corresponding to a virtual reality (VR) environment; obtain low-resolution media data of the VR environment from the media data based on network bandwidth capabilities associated with a user device of a user; identify at least one component within the low-resolution media data having high relevance based on contextual information associated with the user in the VR environment; obtain high-resolution media data corresponding to the low-resolution media data, the high-resolution media data being associated with the at least one component; and render the VR environment based on the low-resolution media data and the high-resolution media data associated with the at least one component in the VR environment. To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

The above and other aspects, features, and advantages of certain embodiments of the present disclosure will be more apparent from the following description taken in conjunction with the accompanying drawings, in which:

FIGS. 1A and 1B illustrate environments for the implementation of a system for processing media data in a virtual reality (VR) environment, in accordance with an embodiment of the present disclosure;

FIG. 2 illustrates a block diagram of the system and components of the system for processing the media data in the VR environment, in accordance with an embodiment of the present disclosure;

FIG. 3 illustrates a block diagram associated with the system and one or more modules of the system for processing the media data in the VR environment, in accordance with an embodiment of the present disclosure;

FIG. 4 illustrates a block diagram associated with a profile management module of the system for processing the media data in the VR environment, in accordance with an embodiment of the present disclosure;

FIG. 5 illustrates a flow chart illustrating a process of a low-resolution data processing (LRDP) module of the system for processing the media data in the VR environment, in accordance with an embodiment of the present disclosure;

FIG. 6 illustrates a block diagram associated with a weight assignment module of the system, in accordance with an embodiment of the present disclosure;

FIG. 7 illustrates a schematic diagram depicting weight assignment of one or more components visible within the media data, in accordance with an embodiment of the present disclosure;

FIG. 8 illustrates a flow chart of a process for generating a three-dimensional (3D) space around the one or more components, in accordance with an embodiment of the present disclosure;

FIG. 9 illustrates a flow chart depicting a process for rendering the media data based on updated information, in accordance with an embodiment of the present disclosure;

FIG. 10 illustrates a use-case of the system for processing the media data in the VR environment, in accordance with an embodiment of the present disclosure;

FIG. 11 illustrates a use-case of the system for processing the media data in the VR environment, in accordance with an embodiment of the present disclosure;

FIG. 12 illustrates a flow chart depicting a process for processing the media data in the VR environment, in accordance with an embodiment of the present disclosure; and

FIG. 13 illustrates a flow chart depicting a process for determining the relevance score for processing the media data in the VR environment, in accordance with an embodiment of the present disclosure.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, “includes”, “including”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Embodiments of the present disclosure will be described below in detail with reference to the accompanying drawings.

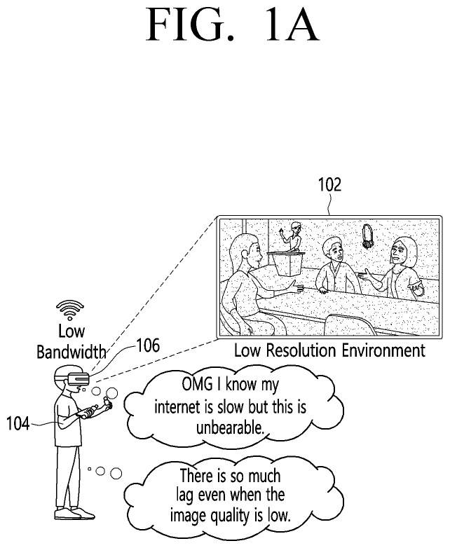

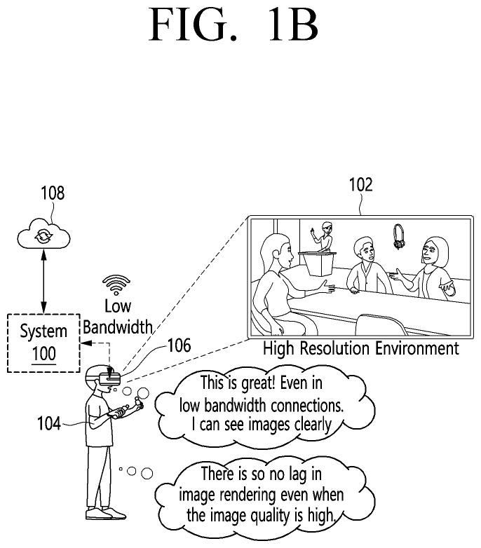

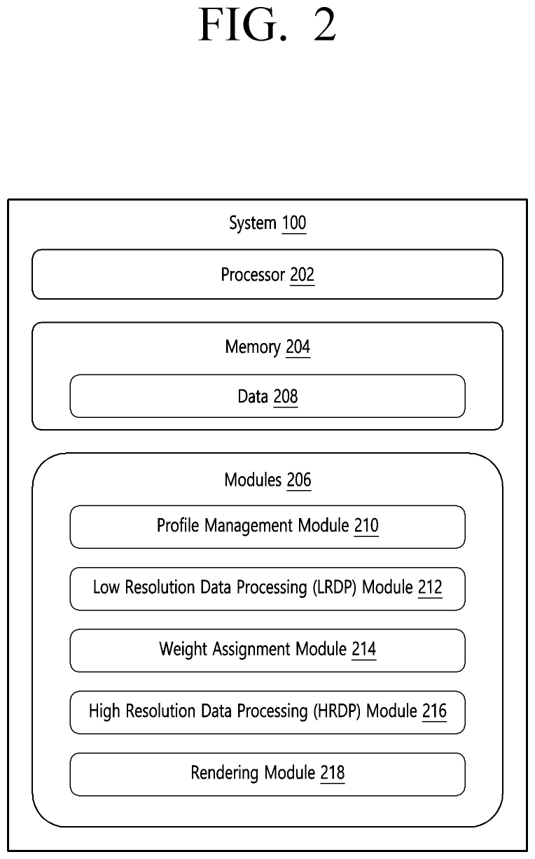

For the sake of clarity, the first digit of a reference numeral of each component of the present disclosure is indicative of the figure number, in which the corresponding component is shown. For example, reference numerals starting with digit “1” are shown at least in FIG. 1. Similarly, reference numerals starting with digit “2” are shown at least in FIG. 2.

FIGS. 1A and 1B illustrates an environment for the implementation of a system 100 for processing media data 102 in a virtual reality (VR) environment, in accordance with an embodiment of the present disclosure.

In an embodiment, the system 100 may facilitate the VR environment that may be accessed by one or more users 104 (also referred to as the user 104) through one or more user devices 106 (also referred to as the user device 106). The system 100 may assign and render media data 102 based on interactions of the user 104 in the virtual environment. The virtual environment may be a digitally created interactive three-dimensional (3D) space for providing the user 104 with an immersive experience. The user 104 may navigate and interact within the VR environment using the user device 106.

In an embodiment, the system 100 may be implemented in the user device 106. In an embodiment, the system 100 for processing the media data 102 in the VR environment, the system 100 may communicate with a remote server or a cloud 108. The cloud 108 may be connected to the user device 106 including, but not limited to, VR headsets, smart phones, computers, haptic feedback tracking devices, eye tracking sensors, microphones, and other peripherals. The media data 102 may include, but are not limited to, visual and audio data related to the VR environment. Visual and audio data may include, but may not be limited to, three-dimensional (3D) avatars of the one or more users 104, 3D models, spatial audio, videos, interactive elements, 2D and 3D image frames, and environmental data.

In an embodiment, the user device 106 and the cloud 108 may be in communication with each other through various technologies like wired e.g., Ethernet or wireless e.g., Wi-Fi connections. The wireless communication network may include wired networks, wireless networks, such as cellular telephone networks like 4G, 5G, 802.11, 802.16, 802.20, 802.1Q, Wi-Fi, or a WiMax.

In exemplary scenario, as seen in FIGS. 1A and 1B, the user 104 through the user device 106 (VR headset and handheld controllers) may engage with the virtual environment. The user device 106 may be connected to the cloud 108 over a network based on available network bandwidth. The virtual environment depicted in the media data 102 corresponds to a virtual meeting or a social interaction setting. The media data 102 displays avatars of the one or more users 104 engaged in a conversation.

FIG. 1A illustrates that the user 104 may be experiencing difficulties while interacting within the VR environment due to low resolution environment. In particular, the user 104 may be experiencing low resolution data of the virtual environment due to limited bandwidth. The frustration of the user 104 underscores common hurdles in VR experiences where technical glitches may significantly disrupt the immersive experience, often leading to user dissatisfaction and a sense of disconnection from intended virtual interaction. FIG. 1B illustrates the user 104 is satisfied with the VR experience irrespective of having limited network bandwidth due to the implementation of the system 100.

The present disclosure provides further details with respect to the system 100 and an implementation of one or more modules of the system 100 in forthcoming paragraphs of FIGS. 2-9.

FIG. 2 illustrates a schematic block diagram of the system 100 and components of the system 100 for processing the media data 102 in the VR environment, in accordance with an embodiment of the present disclosure.

In an embodiment, the system 200 may include, but is not limited to, one or more processors, represented in FIG. 2 as processor 202, one or more memory represented in FIG. 2 as memory 204, one or more modules 206 or alternatively referred to as the modules 206. The modules 206 and the memory 204 may be coupled to the processor 202.

The processor 202 may be a single processing unit or several units, all of which could include multiple computing units. The processor 202 may include specialized processing units such as integrated system (bus) controllers, memory management control units, floating point units, graphics processing units, digital signal processing units, etc. In one embodiment, the processor 202 may include a Central Processing Unit (CPU), a Graphics Processing Unit (GPU), or both. The processor 202 may be one or more general processors, Digital Signal Processors (DSPs), Application-Specific Integrated Circuits (ASIC), Field-Programmable Gate Arrays (FPGAs), servers, networks, digital circuits, analog circuits, combinations thereof, or other now known or later developed devices for analyzing and processing data. The processor 202 may execute a software program, such as code generated manually (i.e., programmed) to perform the desired operation. In one embodiment, the processor/controller 202 may be disposed in communication with one or more Input/Output (I/O) devices via I/O interface 204. The I/O interface 204 may employ communication Code-Division Multiple Access (CDMA), High-Speed Packet Access (HSPA+), Global System for Mobile communications (GSM), Long-Term Evolution (LTE), Worldwide Interoperability for Microwave Access (WiMAX), or the like, etc.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 204 may alternatively be referred to as the database 204 in the present disclosure, within the scope of the disclosure.

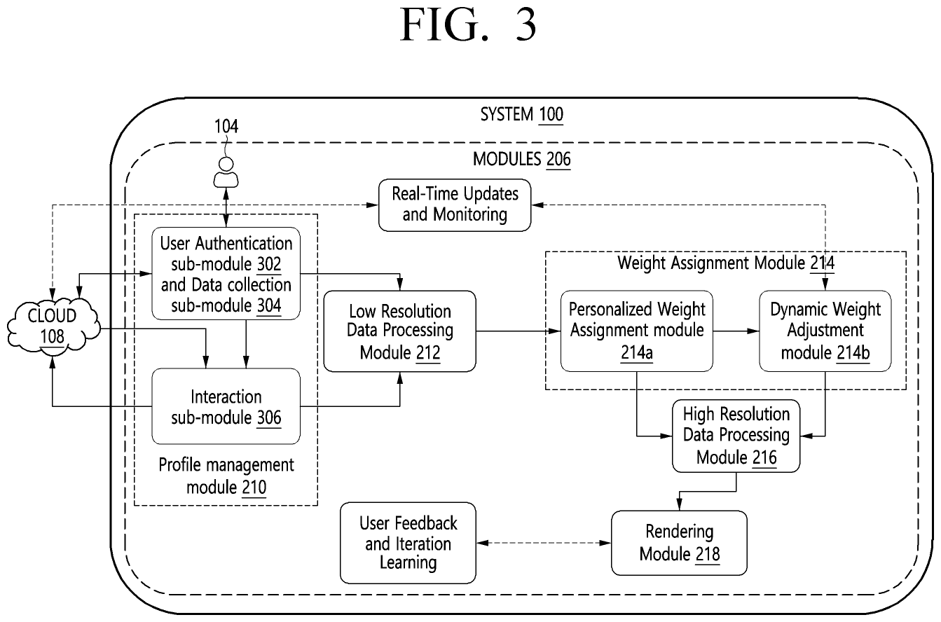

In an embodiment, the processor 202 may be disposed in communication with the memory 204. The processor 202 may be configured to receive the media data 102 corresponding to the VR environment. The processor 202 may further be configured to determine low-resolution media data of the VR environment from the received media data 102 based on network bandwidth capabilities associated with the user device 106 of the user 104. The processor 202 may also be configured to determine at least one region within the low-resolution media data based on contextual information associated with the user 104 in the VR environment. The processor 202 may further be configured to obtain high-resolution media data corresponding to the low-resolution media data based on the determined at least one region. The functionalities of the processor 202 may further be executed by the modules 206. The detailed explanation of each of the operation perform by the processor 202 may be further explained in reference to subsequent FIGS. 3-9.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 may be implemented in hardware, instructions executed by a processing unit, or by a combination thereof. The processor 202 may comprise a computer, a processor, a state machine, a logic array, or any other suitable devices capable of processing instructions. The processing unit may be a general-purpose processor (e.g., processor 202) which executes instructions to cause the general-purpose processor to perform the required tasks, or the processing unit can be dedicated to performing the required functions. In another embodiment of the present disclosure, the modules 206 may be machine-readable instructions (software) which, when executed by the processor 202/processing unit, perform any of the described functionalities/methods, as discussed throughout the present disclosure. The modules 206 in communication with the processor 202 may execute one or more functions as discussed above.

In an embodiment, the modules 206 may include a profile management module 210, a Low-Resolution Data Processing (LRDP) module 212, a weight assignment module 214, a High-Resolution Data Processing (HRDP) module 216, and a rendering module 218. The profile management module 210, the LRDP module 212, the weight assignment module 214, the HRDP module 216, and the rendering module 218 may be in communication with each other. The data 208 serves, amongst other things, as a repository for storing data processed, received, and generated by the modules 206. In an example, the modules 206 may be in communication with the remote server or the cloud 108. Further, FIGS. 3-9 provide a detailed description of each of the modules 206 and related sub-modules.

FIG. 3 illustrates a block diagram associated with the system 100 and the one or more module 206 of the system 100, in accordance with an embodiment of the present disclosure.

In an embodiment, the modules 206 may include the profile management module 210, the LRDP module 212, the weight assignment module 214, the HRDP module 216, and the rendering module 218. The profile management module 210 may be configured to manage user profile, including, but not limited to, storing and updating user preferences, historical data, and one or more interaction patterns. The profile management module 210 includes a user authentication sub-module 302, a data collection sub-module 304, and an interaction sub-module 306. In an example, the user authentication sub module 302 may verify authentication details of the user 104. For instance, the user authentication sub-module 302 may receive a username and a password from the user 104 to authenticate the user profile. Embodiments are exemplary in nature, the user authentication sub module 302 may utilize any suitable authentication technique to verify an identity of the user and/or the user profile. After the user profile being authenticated, historical data associated with the user profile based on one or more interaction patterns, purpose, preferences of the user 104 may be identified by the data collection sub-module 304. The data collection sub-module 304 may further update the data based on user behavior in the virtual environment.

In an embodiment, the interaction sub-module 306 may connect with the cloud/remote server 108 and obtain the media data 102 of the virtual environment from the cloud/remote server 108 based on the network bandwidth capabilities. The interaction sub-module 102 may further determine low resolution media data from the received media data 102 and sends the low-resolution media data to the LRDP module 212.

In an embodiment, the LRDP module 212 may be configured to process the low-resolution media data to identify one or more components visible within the virtual environment using machine learning techniques. The one or more components may include, but may not be limited to, 3D avatars of the users accessing the virtual environment, one or more objects visible within the virtual environment, one or more virtual objects that users interact with, etc. In an example, the one or more components within the low-resolution media data may be identified through convolutional neural network (CNN) model. The CNN model may be trained to identify one or more components of the low-resolution media data. In another example, the CNN model may identify, but may not be limited to, 3D avatars of the users accessing the virtual environment, objects associated with the virtual environment, an ambience etc. The low-resolution media data processed by the LRDP module may be transmitted to the weight assignment module for further processing.

In an embodiment, the weight assignment module 214 may be configured to assign weights to the one or more components based on a plurality of parameters. The weight assignment module 214 may further include a personalized weight assignment module 214a and a dynamic weight assignment module 214b. The personalized weight assignment module 214a may receive data associated with the user profile of the user 104 from the data collection sub-module 304. Based on the data associated with the user profile, the personalized weight assignment module 214a may assign initial values or weights to the one or more components within the low-resolution media data. In an example, if the user 104 interacts with a specific feature within the virtual environment as suggested by the historical data associated with the user profile. The personalized weight assignment module 214a may then provide a higher initial value or a higher weight to the specific feature.

In an embodiment, the dynamic weight assignment module 214b may assign weights to the one or more components based on the user behavior within the virtual environment. In an example, the user 104 is speaking to another user then the dynamic weight assignment module 214b may allocate more weight to act of speaking and to the other user with whom the user 104 may be speaking to, so that an audio and a video related to the act of speaking may be prioritized over other tasks and/or activities in the virtual environment. As an example, in embodiments, the dynamic weight assignment module may allocate higher weight to another user the user is interacting with or an object in the virtual environment the user is interacting with. In embodiments, the assigned weight may be higher than a threshold based on the user interaction with the another user or the object.

In an embodiment, the HRDP module 216 may selectively obtain high resolution media data for the one or more components based on the assigned weights. In an example, the HRDP module 216 downloads the one or more components that may be prioritized by the dynamic weight assignment module 214b.

In an embodiment, the rendering module 218 may obtain the low-resolution media data from the LRDP module 212 and corresponding high-resolution media data from the HRDP module 216. The rendering module 218 may further superimpose the high-resolution media data on the low-resolution media data to display at least one region of the media data having the one or more components with higher weights in high-resolution. In an embodiment, the dynamic weight assignment sub-module 214b may update weights assigned to the one or more components based on user feedback and iterative learning. In embodiments, the rendering module 218 may further superimpose the high-resolution media data on the low-resolution media data to display one or more components of the media data with higher weights in high-resolution. In an embodiment, the dynamic weight assignment sub-module 214b may update weights assigned to the one or more components based on user feedback and iterative learning.

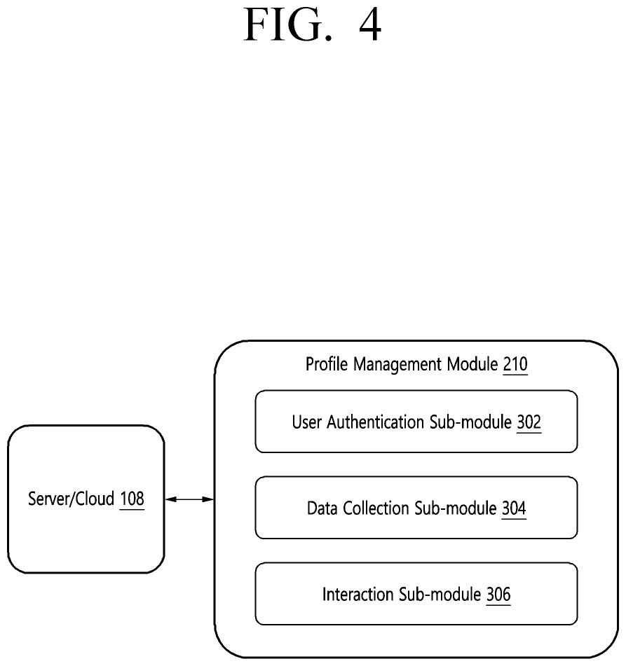

FIG. 4 illustrates a block diagram associated with the profile management module 210 of the system 100, in accordance with an embodiment of the present disclosure.

In an embodiment, the profile management module 210 may include the user authentication sub-module 302, the data collection sub-module 304, and the interaction sub-module 306. The user authentication sub-module 302 may be configured to manage a login and authentication process for the one or more users 104 accessing the virtual environment. The user authentication sub-module 302 may verify user credentials and ensure that only authorized users may access the virtual environment. The user authentication sub-module 302 may include, but may not be limited to, authenticating usernames, passwords, biometric data, or other authentication mechanisms to maintain security while accessing the virtual environment. The user authentication sub-module 302 may further be configured to create and manage user profiles based on the user authentication.

In an embodiment, the data collection sub-module 304 may gather data related to activities, preferences, and interactions of the one or more users 104 within the virtual environment. The data collection sub-module 304 may monitor the user behavior within the virtual environment and collects information of the user based on the user behavior. The data collection sub-module 304 may further store the data to identify purpose and the one or more interaction patterns associated with the one or more users 104 within the virtual environment.

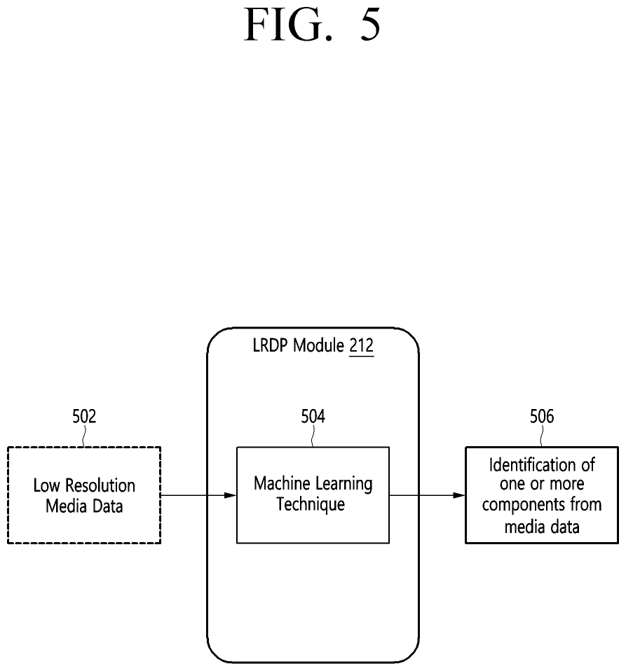

In an embodiment, the interaction sub-module 306 may connect with the cloud 108 to access/download the media data 102 in low-resolution based on network bandwidth capabilities associated with the user device 106 of the user 104. The interaction sub-module 306 may then provide the media data 102 received in low-resolution to the LRDP module 212 for further processing. A detailed explanation of the LRDP module 212 is provided in FIG. 5.

FIG. 5 illustrates a process for the LRDP module 212 of the system 100, in accordance with an embodiment of the present disclosure.

In an embodiment, at operation 502, the LRDP module 212 receives the media data 102 in low-resolution based on the network bandwidth capabilities associated with the user device 106. At operation 504, the LRDP module 212 may identify the one or more components visible within the media data 102 using a machine learning technique such as, but not limited to, convolutional neural network (CNN). The machine learning technique may be effective in analyzing the media data 102 in low-resolution and detect the one or more components within the media data, such as, but is not limited to, 3D avatars, objects and features related to the virtual environment.

At operation 506, the detected one or more components and information associated with the one or more components may then be transferred to the weight assignment module 214.

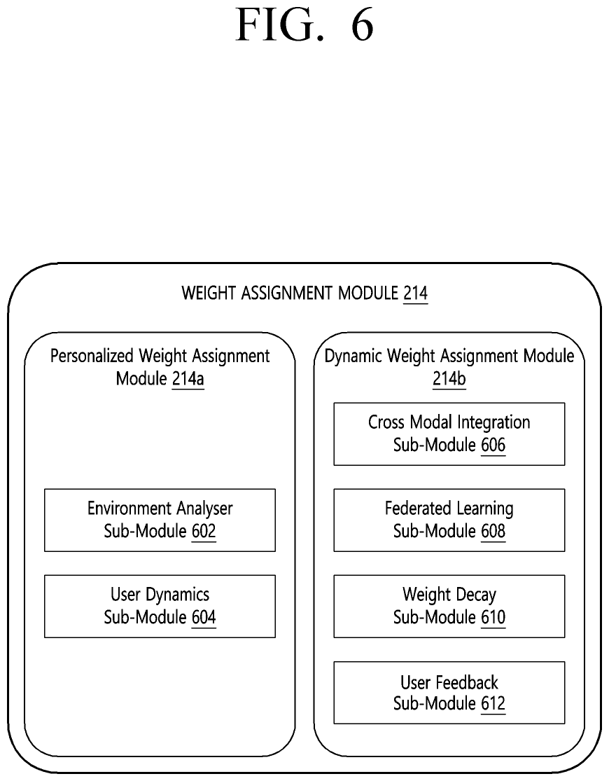

FIG. 6 illustrates a block diagram associated with the weight assignment module 214 of the system 100, in accordance with an embodiment of the present disclosure.

In an embodiment, the weight assignment module 214 may comprise of the personalized weight assignment module 214a and the dynamic weight assignment module 214b. The personalized weight assignment module 214a and the dynamic weight assignment module 214b may include a plurality of sub-modules 602-612. The plurality of sub-modules 602-612 may be configured to detect a plurality of predetermined parameters. The personalized weight assignment module 214a may include an environment analyzer sub-module 602 and a user dynamics sub-module 604. The dynamic weight assignment module 214b may include a cross modal integration sub-module 606, a federated learning sub-module 608, a weight decay sub-module 610, and a user feedback sub-module 612.

In an embodiment, the environment analyzer sub-module 602 may be configured to analyze the user profile based on the information available from the profile management module 210. The environment analyzer sub-module 602 may detect emotional states and reactions of the user 104 within the virtual environment based on the analyzed user profile. The environment analyzer sub-module 602 may process the data and assign weights to different features of the virtual environment based on the reactions and emotional state of the user 104. In an example, the environment analyzer sub-module 602 may prioritize high-resolution rendering of the avatar of another user with whom the user 104 is engaged in a conversation within the virtual environment.

In an embodiment, the user dynamics sub-module 604 may be adapted to assign weights to temporal and contextual information from the virtual environment. The temporal information may include, but is not limited to, time of day, specific day of week, and specific events occurring within the virtual environment. The user dynamics sub-module 604 may be adapted to respond to the changing preferences of the user 104 over time.

Further, the contextual information may include, but is not limited to, a current activity of the user 104, and the one or more user interaction patterns with the one or more components present within the virtual environment. The user dynamics sub-module 604 may assign the weight to the one or more components based on the current activity and the one or more interaction patterns of the user 104. In an example, during an event in the virtual environment, user dynamics sub-module 604 may increase the weight of one or more components related to the event, e.g., increase the weight higher than a threshold, thereby ensuring the users to have an enhanced experience within the virtual environment even with the limited network bandwidth capabilities of the user device 106. The personalized weight assignment module 214a and the related sub-modules may be adapted to provide initial values to the one or more components.

In an embodiment, the dynamic weight assignment module 214b may be adapted to assign weights to the one or more components based on the plurality of predetermined parameters determined by the modules 606-612. In an embodiment, the cross-modal integration module 606 may be adapted to assign weights by integrating information across a plurality of interaction modes within the virtual environment, such as visual, auditory, and haptic modalities. In an embodiment, the federated learning sub-module 608 may be adapted to identify groups/community of the user 104 with similar interests or goals. The federated learning sub-module 608 may assign weights that cater to specific needs of each group/community within the virtual environment. The federated learning sub-module 608 may assign weights across similar users while maintaining privacy and security.

In an embodiment, the weight decay sub-module 610 may be adapted to reduce an impact of outdated information on weight assignments by gradually decreasing an importance of historical data and prioritizing recent interactions based on user feedback. In an example, if the user 104 frequently interacts with a new feature, the weight decay sub-module 610 may assign higher importance to the interaction with the new feature while diminishing a relevance of older and less frequent activities.

In an embodiment, the user feedback sub-module 612 may be adapted to utilize a machine leaning technique to predict optimal weights based on the one or more interaction patterns of the user 104. The machine leaning technique may be a trained reinforcement learning model that may be adapted to learn the one or more interaction patterns in user behavior and dynamically adjusts weights to enhance user satisfaction and engagement. The user feedback sub-module 612 may gather information on the user feedback through the plurality of predetermined parameters and adjust the weight assignment to align with user expectations and needs.

In an embodiment, the plurality of predetermined parameters may include the one or more of user interaction patterns, the user purpose, the groups of users with similar interests, spatial information of the one or more components in the VR environment, the time, the date, the event type, the sensory inputs such as visual, auditory, haptic, and the weight decay factor. The plurality of predetermined parameters may be received from the plurality of the sub-modules 602-612.

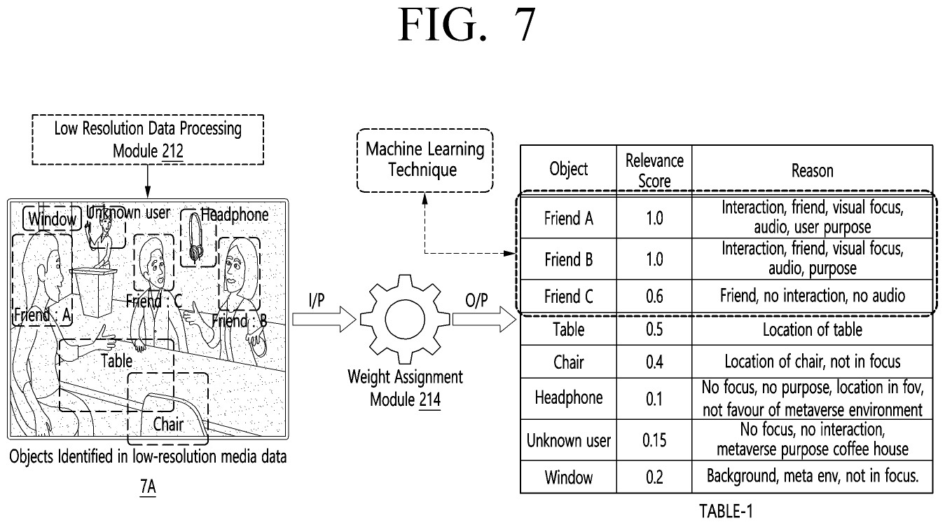

FIG. 7 illustrates a schematic diagram depicting weight assignment of the one or more components visible within the media data 102, in accordance with an embodiment of the present disclosure.

In an embodiment, as shown in scene 710, the media data 102 with the identified one or more components may be received from the LRDP module 212 by the weight assignment module 214. The weight assignment module 214 may be configured to determine a relevance score for each of the one or more components within the VR environment. To determine the relevance score, firstly the initial values may be assigned to each of the one or more components based on the user profile. Secondly, each of the one or more components may be assigned weights based on the plurality of predetermined parameters. Lastly, the relevance score may be determined for each of the one or more components based on the corresponding initial value and the assigned weight.

In an embodiment, the relevance score of the one or more components may be determined by equation (1) provided as follows:

$$Relevance Score = initial value * assigned weight \qquad Eqn ( 1 )$$

Updated relevance score may be calculated with the help of learning mean gradient (LMG) determined by equation (2) provided as follows:

$$LMG = {\sum }_{p arameter = user behaviour}^{p arameter = weight decay} \frac{initial value of the parameter * assigned weight}{n umber of parameters} \qquad Eqn ( 2 )$$

The LMG aggregates the product of the initial values of the plurality of predetermined parameters and corresponding assigned weights. The plurality of predetermined parameters ranges from the user behavior to the weight decay factor. The plurality of predetermined parameters may further include the one or more of user interaction patterns, the user purpose, the groups of users with similar interests, spatial information of the one or more components in the VR environment, the time, the date, the event type, the sensory inputs such as visual, auditory, haptic, and the weight decay factor. The aggregated value is then divided by the total number of parameters. Therefore, the LMG may factor in both the initial parameter values and their respective weights, averaged over the number of parameters, to reflect an impact of user behavior and a gradual reduction in importance of outdated information through an application of the weight decay factor.

Furthermore, an updated relevance score may be computed from the equation (3) as provided below:

updated relevance score=updated LMG*initial value of the one or more component Eqn (3)

The updated relevance score of the component may be calculated by multiplying the updated LMG with the initial value of the component.

As illustrated in the Table-1, the one or more components may be identified, and the corresponding relevance score may be computed based on the plurality of predetermined parameters. As shown, the one or more components may be sorted based on the relevance score. Corresponding sizes of the one or more components may then be determined. The one or more components may be obtained in high-resolution based on a threshold value. The threshold value may be computed based on an available network bandwidth capability and the corresponding sizes of the one or more components. The one or more components may be obtained in high-resolution which may be determined by equations (4) to (6) provided as follows:

$$size = 0 , S . no = 1 \qquad Eqn ( 4 )$$

$$while ( BC > size ) \{ size = size + Size of Object [ S . no ] S . no ++ \} \qquad Eqn ( 5 )$$

$$Threshold Value = Weight of Object [ S . no ] \qquad Eqn ( 6 )$$

Where, BC is bandwidth capacity, size is size of the one or more components, S.No is serial number of the one or more components as provided in the Table-1, threshold value is a weight above which the one or more components may be fetched in high resolution.

The equations (4) to (6) may determine a loop that calculates the size of one or more components provided in Table-1 exceeds the bandwidth capacity (BC). The loop initializes the total size to 0 and starts with the first object (S.no=1). Inside the loop, the size of each component may be added and increments the component counter (S.no). The loop continues until the total size of the one or more components may exceeds the bandwidth capacity. Once the loop exits, the weight of the current object (at the breaking point) is set as the threshold value for prioritizing the one or more components. It is understood that the examples in FIG. 7 are embodiments but the present disclosure is not limited thereto.

As an example, the identified one or more components include friend A, friend B, and friend C, table, chair, headphone, unknown user, and window. Based on the plurality of predetermined parameters, weights may be assigned to each of the one or more components. Based on the assigned weight, the relevance score of each component may be identified. The components having the higher relevance score may be obtained in high-resolution subject to the network bandwidth capability. The size of the avatar of friend A, friend B, and friend C may be rendered and displayed in high-resolution since the total size of the avatars is equivalent to the network bandwidth capability. Therefore, the system 100 may optimize a usage of network bandwidth capability by selectively downloading the one or more components in high-resolution data.

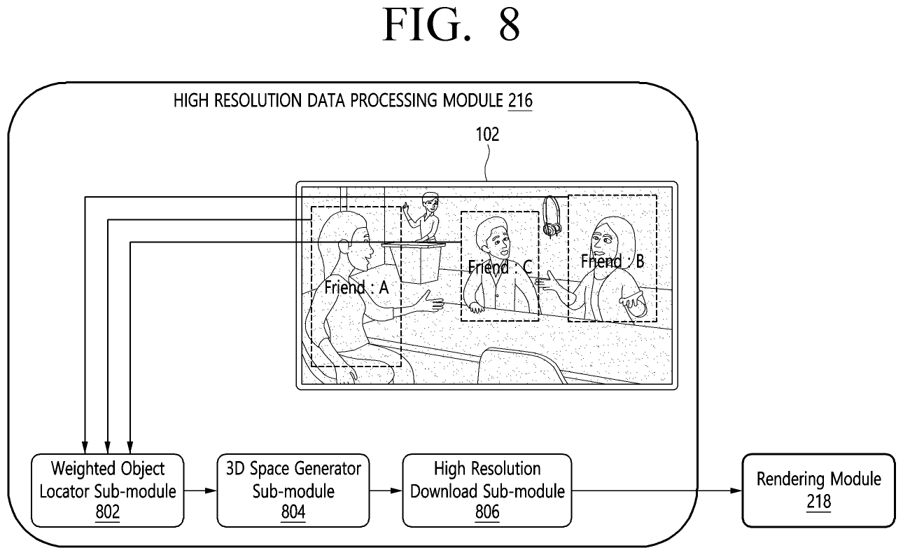

FIG. 8 illustrates a process flow chart of generating a three-dimensional (3D) space around the one or more components, in accordance with an embodiment of the present disclosure.

The HRDP module 216 may include a weighted object locator sub-module 802, a 3D generator sub-module 804, and a high resolution download sub-module 806. The weighted object locator sub-module 802 may be adapted to obtain a plurality of positional coordinates of the one or more components selected by the weight assignment module 214 based on the relevance score and the network bandwidth capability.

In an embodiment, the 3D space generator 804 may be configured to generate a 3D space near the selected one or more components. The 3D space generator 804 may be configured to identify positional coordinates of nearby components based on the plurality of positional coordinates of the selected one or more components.

In an embodiment, the positional coordinates of the selected one or more components (herein, Friend A, Friend B, and Friend C) may be obtained by the high resolution download sub-module 806. Further, positional coordinates of nearby components may also be obtained based on the positional coordinates of the Friend A, Friend B, and Friend C. Accordingly, the nearby components may also be obtained in high resolution by the high resolution download sub-module 806, thereby generating the 3D space around the one or more components. Hence, at least one region having the one or more components and the nearby components may be obtained in high resolution with the help of the HRDP module 216.

In an embodiment, the rendering module 218 may be configured to obtain high resolution media data corresponding to the at least one region in the VR environment. The rendering module 218 may further be configured to superimpose the high resolution media data on the low-resolution media data in accordance with the determined positional coordinates of the one or more components within the virtual environment. Further, rendering module 218 may then be configured to render the VR environment based on the low-resolution media data and the high-resolution media data.

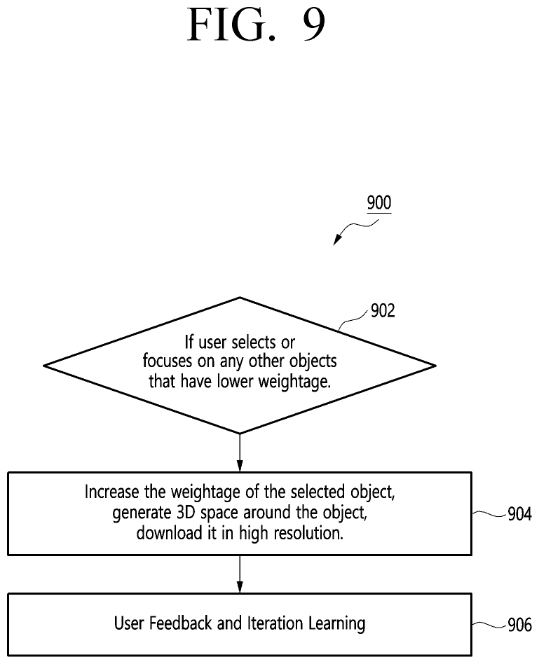

FIG. 9 illustrates a flow chart depicting a process 900 for rendering the media data 102 based on updated information, in accordance with an embodiment of the present disclosure. The method 900 may be implemented by the modules 206.

At operation 902, the weight assignment module 214 may detect a change in the plurality of predetermined parameters including the user feedback within the rendered VR environment.

At operation 904, the weight assignment module 214 may be adapted to update the weights of the one or more components based on the change. The weight assignment module 214 may then determine an updated relevance score of the one or more components. The HRDP module 216 may then generate the 3D space around the one or more components and obtain the at least one region of the VR environment in high resolution based on the updated relevance score.

At operation 906, the weight assignment module 214 may iteratively update the weights based on the change in the plurality of predetermined parameters and prioritize the one or more components based on the updated relevance score. The weight assignment module 214 may also be adapted to store the updated weights of the one or more components within the user profile for future reference.

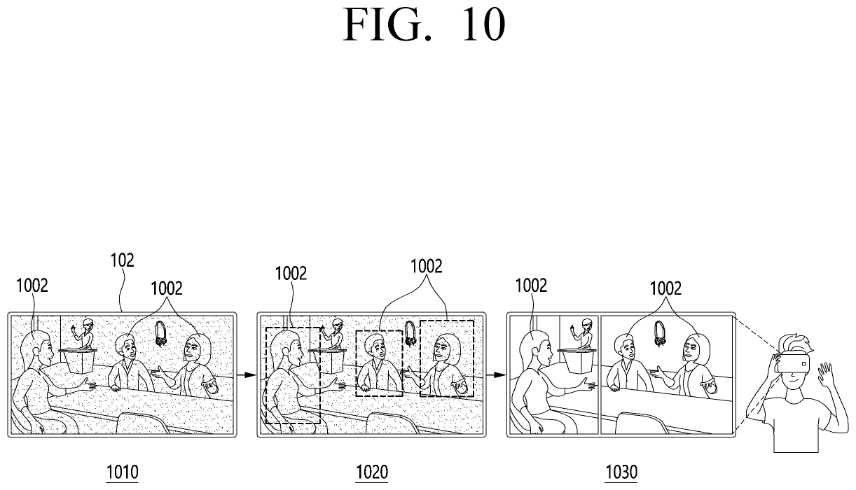

FIG. 10 illustrates a use-case of the system 100 for processing the media data 102 in the VR environment, in accordance with an embodiment of the present disclosure.

In scene 1010, the system 100 may obtain the media data 102 in low-resolution based on the network bandwidth capabilities of the user device 106 of the user 104. In illustration scene 1020, the system 100 may further identify the one or more components 1002 within the media data 102 available in low-resolution using the machine learning technique. Further, in scene 1030, the system 100 may then obtain the identified one or more components 1002 in high-resolution based on the network bandwidth capabilities of the user device 106. The system 100 then superimposes the one or more components 1002 obtained in high-resolution on the media data 102 available in low-resolution for the user 104. Therefore, the system 100 displays the identified one or more components 1002 in high-resolution while the remaining one or more components may be in low-resolution.

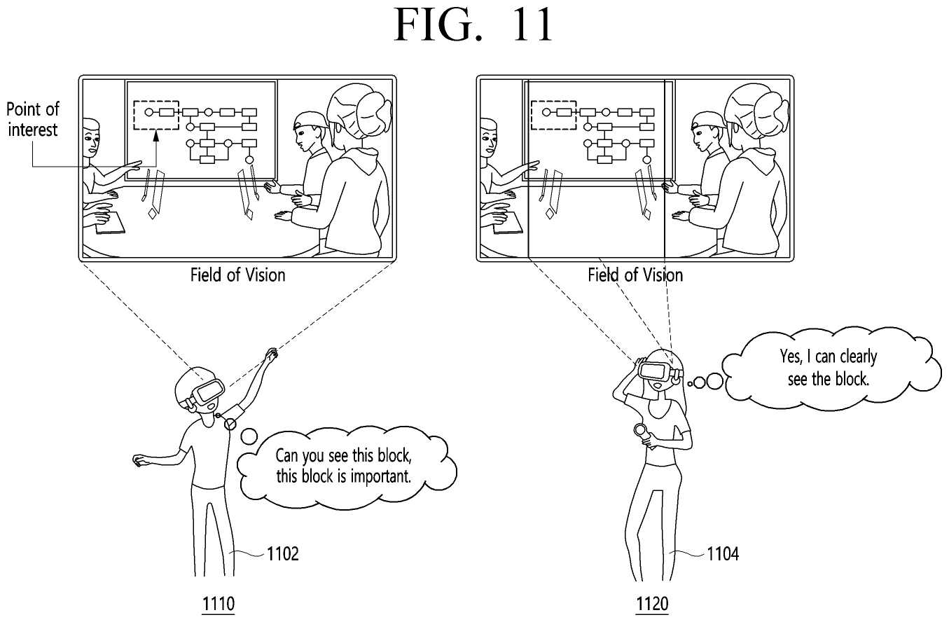

FIG. 11 illustrates another use-case of the system 100 for processing the media data 102 in the VR environment, in accordance with an embodiment of the present disclosure.

In scene 1110, a virtual meeting scenario may be depicted. The user 1102 may have a wider field of vision, as depicted in scene 1110, based on the network bandwidth capabilities. However, in scene 1120, the user 1104 may have a narrower field of vision focusing only on a presentation that is displayed during the meeting within the virtual environment based on the network bandwidth capabilities associated with the user device 106 of the user 1104. Therefore, the system 100 may enable the user 1104 to see the presentation in high-resolution without any latency issues.

Furthermore, the user 1102 may be directing the user 1104 to look at an object within the presentation. The field of view for the user 1104 may now be shortened. Based on the conversation, the weights may be again reallocated, thus shortening the field of view of the user 1104.

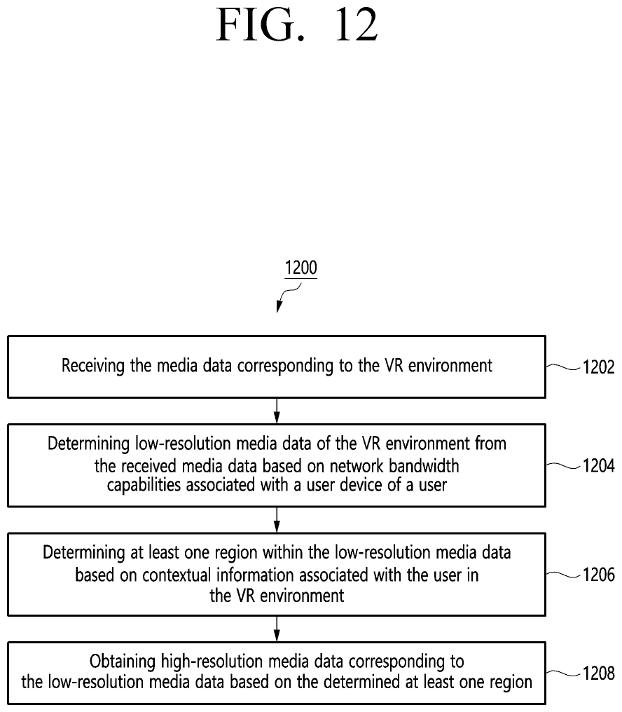

FIG. 12 illustrates a flow chart depicting a process 1200 for processing the media data 102 in the VR environment, in accordance with an embodiment of the present disclosure.

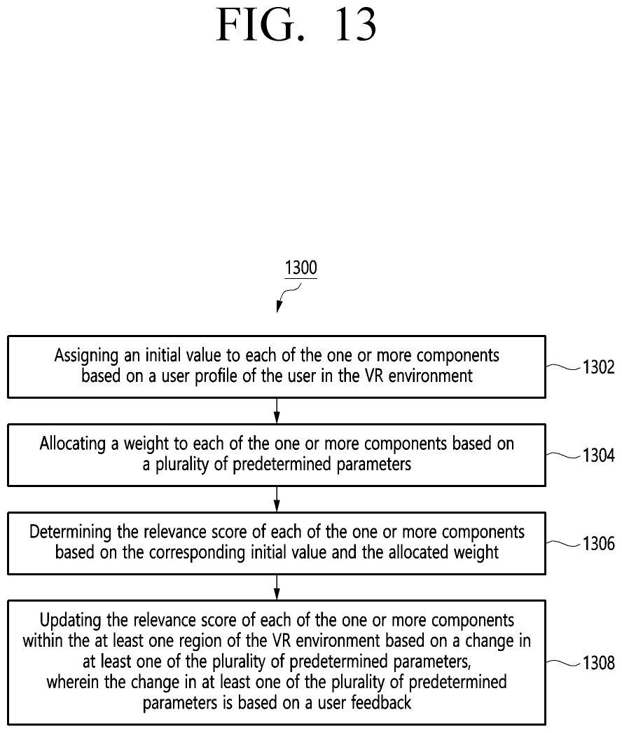

FIG. 13 illustrates a flow chart depicting the process 1300 for determining the relevance score for processing the media data 102 in the VR environment, in accordance with an embodiment of the present disclosure. The processes 1200 and 1300 may be a computer-implemented methods executed, for example, by the user device 106 and the modules 206. For the sake of brevity, constructional and operational features of the system 100 that are already explained in the description of FIGS. 2-9 are not explained in detail in the description of FIGS. 12 and 13.

At operation 1202, the process 1200 may include receiving the media data 102 corresponding to the VR environment.

At operation 1204, the process 1200 may include determining the media data 102 in low-resolution of the VR environment from the received media data 102 based on network bandwidth capabilities associated with the user device 106 of the user 104.

At operation 1206, the process 1200 may include determining the at least one region within the low-resolution media data 102 based on the contextual information associated with the user 104 in the VR environment.

At operation 1208, the process 1200 may include obtaining the media data 102 in high-resolution corresponding to the low-resolution media data 102 based on the determined at least one region.

At operation 1206, the process 1200 may further include determining the relevance score for each of the one or more components within the at least one region of the VR environment based on the contextual information. The method 1200 includes various steps to determine the relevance score as depicted in FIG. 13. The steps are as follows:

At operation 1302, the process 1300 may include assigning the initial value to each of the one or more components based on the user profile of the user 104 in the VR environment.

At operation 1304, the process 1300 may also include allocating the weight to each of the one or more components based on the plurality of predetermined parameters.

At operation 1306, the process 1300 may further include determining the relevance score of each of the one or more components based on the corresponding initial value and the allocated weight.

At operation 1308, the process 1300 may include updating the relevance score of each of the one or more components within the at least one region of the VR environment based on a change in at least one of the plurality of predetermined parameters. The change in at least one of the plurality of predetermined parameters may be based on the user feedback.

The present disclosure optimizes the network bandwidth capabilities and reduces lag while displaying the VR environment thereby enhancing user experience. The VR environment may be rendered and displayed based on the user profile and the plurality of predetermined parameters. The system 100 selectively obtains the one or more components within the VR environment based on assignment of weights dynamically. Real-time responsiveness through the assignment of weights dynamically, data-driven decision-making from continuous user feedback, and secure federated learning ensure a seamless, personalized, and secure VR experience.

The system 100 prioritizes and downloads the high-resolution media data thereby reducing latency and ensuring that the users receive detailed information quickly, especially in dynamic and interactive metaverse scenarios. Further, the system 100 allows for a personalized experience by considering the user's purpose, social interactions, and preferences. The system 100 tailors a level of detail in different parts of the virtual environment based on individual user needs.

Further, as users engage in different activities within the virtual environment, the system 100 dynamically adjusts the focus of high-resolution media data. This adaptability ensures that the system 100 aligns with the user's evolving needs and activities in real-time. Also, prioritizing high-resolution media data in critical areas with other users enhances social interactions. The users may see detailed avatars and surroundings of those they are interacting with, fostering a sense of presence and connection. Furthermore, in scenarios where users have limited network bandwidth or are accessing the metaverse through mobile devices, the system ensures a smoother experience by delivering high-resolution content selectively.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

While example embodiments have been presented in the foregoing detailed description, it should be appreciated that a vast number of variations exist.

What is claimed as:

1. A method for processing media data in a virtual reality (VR) environment, the method comprising:
receiving the media data associated with the VR environment;
obtaining low-resolution media data of the VR environment from the media data based on network bandwidth capabilities associated with a user device of a user;
identifying at least one region within the low-resolution media data based on contextual information associated with the user in the VR environment; and
obtaining high-resolution media data corresponding to the low-resolution media data, the high-resolution media data being associated with the at least one region.

2. The method as claimed in claim 1, further comprising:
rendering the VR environment based on the low-resolution media data and the high-resolution media data associated with the at least one region in the VR environment.

3. The method as claimed in claim 1, further comprising:
determining a relevance score for each of one or more components within the at least one region of the VR environment based on the contextual information.

4. The method as claimed in claim 3, wherein the determining the relevance score comprises:
assigning an initial value to each of the one or more components based on a user profile of the user in the VR environment;
allocating a weight to each of the one or more components based on a plurality of predetermined parameters; and
determining the relevance score of each of the one or more components based on respective initial value and respective allocated weight associated with each of the one or more components.

5. The method as claimed in claim 4, wherein the plurality of predetermined parameters comprises at least one of user interaction patterns, user purpose, groups of users with similar interests, spatial information of the one or more components in the VR environment, time, date, event type, weight decay factor, and sensory inputs.

6. The method as claimed in claim 4, further comprising:
updating the relevance score of each of the one or more components within the at least one region of the VR environment based on a change in at least one of the plurality of predetermined parameters,
wherein the change in at least one of the plurality of predetermined parameters is based on a user feedback.

7. The method as claimed in claim 3, further comprising:
selecting at least one of the one or more components based on the relevance score;
identifying a plurality of positional coordinates in the VR environment corresponding to the selected at least one of the one or more components; and
superimposing high-resolution media data that is associated with the selected at least one of the one or more components on corresponding low-resolution media data based on the plurality of positional coordinates.

8. The method as claimed in claim 3, further comprising:
generating a three-dimensional (3D) space around the one or more components based on the contextual information.

9. A system for processing media data in a virtual reality (VR) environment, the system comprising:
memory storing instructions; and
at least one processor operatively connected to the memory, and configured to execute the instructions,
wherein the instructions, when executed by the at least one processor, cause the system to:
receive the media data corresponding to the VR environment;
obtain low-resolution media data of the VR environment from the media data based on network bandwidth capabilities associated with a user device of a user;
identify at least one region within the low-resolution media data based on contextual information associated with the user in the VR environment; and
obtain high-resolution media data corresponding to the low-resolution media data, the high-resolution media data being associated with the at least one region.

10. The system as claimed in claim 9, wherein the instructions, when executed by the at least one processor, cause the system to:
render the VR environment based on the low-resolution media data and the high-resolution media data associated with the at least one region in the VR environment.

11. The system as claimed in claim 9, wherein the instructions, when executed by the at least one processor, cause the system to:
determine a relevance score for each of one or more components within the at least one region of the VR environment based on the contextual information.

12. The system as claimed in claim 11, to determine the relevance score, the instructions, when executed by the at least one processor, cause the system to:
assign an initial value to each of the one or more components based on a user profile of the user in the VR environment;
allocate a weight to each of the one or more components based on a plurality of predetermined parameters; and
determine the relevance score of each of the one or more components based on respective initial value and respective allocated weight.

13. The system as claimed in claim 12, wherein the plurality of predetermined parameters comprise at least one of:
user interaction patterns, user purpose, groups of users with similar interests, spatial information of the one or more components in the VR environment, time, date, event type, weight decay factor, and sensory inputs.

14. The system as claimed in claim 12, wherein the instructions, when executed by the at least one processor, cause the system to:
update the relevance score of each of the one or more components within the at least one region of the VR environment based on a change in at least one of the plurality of predetermined parameters, wherein the change in at least one of the plurality of predetermined parameters is based on a user feedback.

15. The system as claimed in claim 11, wherein the at least one processor is further configured to:
select at least one of the one or more components based on the relevance score;
identify a plurality of positional coordinates in the VR environment corresponding to the selected at least one of the one or more components; and
superimpose high-resolution media data that is associated with the selected at least one of the one or more components on low-resolution media data based on the identified plurality of positional coordinates.

16. A non-transitory computer-readable medium storing instructions, the instructions when executed by one or more processors, causes the one or more processors to:
receive media data corresponding to a virtual reality (VR) environment;
obtain low-resolution media data of the VR environment from the media data based on network bandwidth capabilities associated with a user device of a user;
identify at least one component within the low-resolution media data having high relevance based on contextual information associated with the user in the VR environment;
obtain high-resolution media data corresponding to the low-resolution media data, the high-resolution media data being associated with the at least one component; and
render the VR environment based on the low-resolution media data and the high-resolution media data associated with the at least one component in the VR environment.

17. The non-transitory computer-readable medium as claimed in claim 16, wherein the instructions, when executed, further cause the one or more processors to:
determine a respective relevance score associated with each of one or more components in the VR environment based on a user profile of the user in the VR environment; and
select the at least one component having a relevance score higher than a threshold.

18. The non-transitory computer-readable medium as claimed in claim 17, wherein the relevance score is based on at least one of:
user interaction patterns, user purpose, groups of users with similar interests, spatial information of the one or more components in the VR environment, time, date, event type, weight decay factor, and sensory inputs.

19. The non-transitory computer-readable medium as claimed in claim 17, wherein the instructions, when executed, further cause the one or more processors to:
update the respective relevance score of each of the one or more components, the updating being based on a change in at least one of a plurality of parameters in accordance with user feedback.

20. The non-transitory computer-readable medium as claimed in claim 16, wherein the instructions, when executed, further cause the one or more processors to:
generate a three-dimensional (3D) space around the one or more components based on the contextual information.
